(19) United States
(12) Patent Application Publication
(10) Pub. No.: US 2024/0375631 A1
(43) Pub. Date: Nov. 14, 2024

(54) ELECTRIC BRAKING DEVICE

(71) Applicant: ADVICS CO., LTD., Kariya-shi, Aichi-ken (JP)

(72) Inventors: Takuto KAWAI, Kariya-shi, Aichi-ken (JP); Ryota MAENO, Kariya-shi, Aichi-ken (JP)

(73) Assignee: ADVICS CO., LTD., Kariya-shi, Aichi-ken (JP)

(21) Appl. No.: 18/690,573

(22) PCT Filed: Sep. 28, 2022
(86) PCT No.: PCT/JP2022/036219

§ 371 Date: Mar. 8, 2024

(30) Foreign Application Priority Data
Sep. 30, 2021 (JP) 2021-160372

(51) Int. Cl. B60T 13/74; F16D 65/18; F16D 121/04; F16D 121/24; F16D 125/40; F16D 125/48; F16D 127/06

(52) U.S. Cl. CPC B60T 13/745; F16D 65/18; B60T 2270/414; F16D 2121/04; F16D 2121/24; F16D 2125/40; F16D 2125/48; F16D 2127/06

(57) ABSTRACT

An electric braking device includes an actuator that, in a case in which an electric motor rotates in a second rotational direction due to a piston moving in a second direction which is the direction in which braking force decreases due to an external force, is driven to inhibit the piston from moving in the second direction by using electric power generated by the electric motor as the electric motor rotates in the second rotational direction.

### TECHNICAL FIELD

The present disclosure relates to an electric braking device.

### BACKGROUND ART

Patent Literature 1 discloses an electric braking device that generates braking force by linear motion of a piston in a cylinder using an electric motor as a power source. Examples of the electric braking device include a wet type electric braking device that transmits pressing force of the piston to a friction member via a brake fluid to generate braking force, and a dry type electric braking device that directly transmits pressing force of the piston to the friction member to generate braking force.

### CITATIONS LIST

### Patent Literature

Patent Literature 1: German Patent Application Publication No. 102009019209

### SUMMARY

### Technical Problems

In the electric braking device as described above, when the electric motor loses electric power due to a power failure or the like during generation of the braking force, the piston is pushed back. Then, the durability of the components of the electric braking device may decrease by the impact when the piston runs into the end of the linear motion range in the cylinder.

### Solutions to Problems

Hereinafter, means for solving the above problems and operations and effects thereof will be described.

An electric braking device that solves the above problem is electric braking device that generates a braking force on a vehicle by transmitting, to a linear motion conversion mechanism by a transmission mechanism, a rotational motion generated by an electric motor rotating in a braking force increasing direction, converting the rotational motion into a linear motion for driving a piston provided in a cylinder by the linear motion conversion mechanism, and pressing a friction portion against a portion subjected to friction that rotates together with a wheel of a vehicle, the electric braking device including an actuator that is driven to inhibit movement of the piston in a decreasing direction by using electric power generated by the electric motor by the electric motor rotating in a braking force decreasing direction when the electric motor rotates in the braking force decreasing direction, which is a direction opposite to the braking force increasing direction, by the piston moving in the decreasing direction that is a direction in which the braking force decreases by an external force.

When supply of electric power to the electric motor is blocked in a situation where the electric braking device generates the braking force, the piston may be pushed back vigorously in the decreasing direction by the external force. At this time, since the electric motor rotates in the braking force decreasing direction, the electric motor generates power. Then, the actuator is driven by the electric power generated by the electric motor, thereby decelerating the moving speed of the piston in the decreasing direction. Thus, the electric braking device can mitigate the impact when the piston runs into a terminal in the decreasing direction within a movement range of the piston. As a result, the electric braking device can inhibit durability of the components of the device from decreasing.

### BRIEF DESCRIPTION OF DRAWINGS

FIG. 1 is a schematic diagram of a vehicle including an electric braking device of a first embodiment.

FIG. 2 is a diagram illustrating a circuit configuration of the electric braking device of the first embodiment.

FIG. 3 is a schematic diagram of a vehicle including an electric braking device of a second embodiment.

FIG. 4 is a schematic diagram of a vehicle including an electric braking device of a third embodiment.

FIG. 5 is a schematic diagram of a vehicle including an electric braking device of a fourth embodiment.

FIG. 6 is a schematic diagram of a vehicle including an electric braking device of a fifth embodiment.

### DESCRIPTION OF EMBODIMENTS

### First Embodiment

Hereinafter, the vehicle including the electric braking device according to the first embodiment will be described.

### <Vehicle>

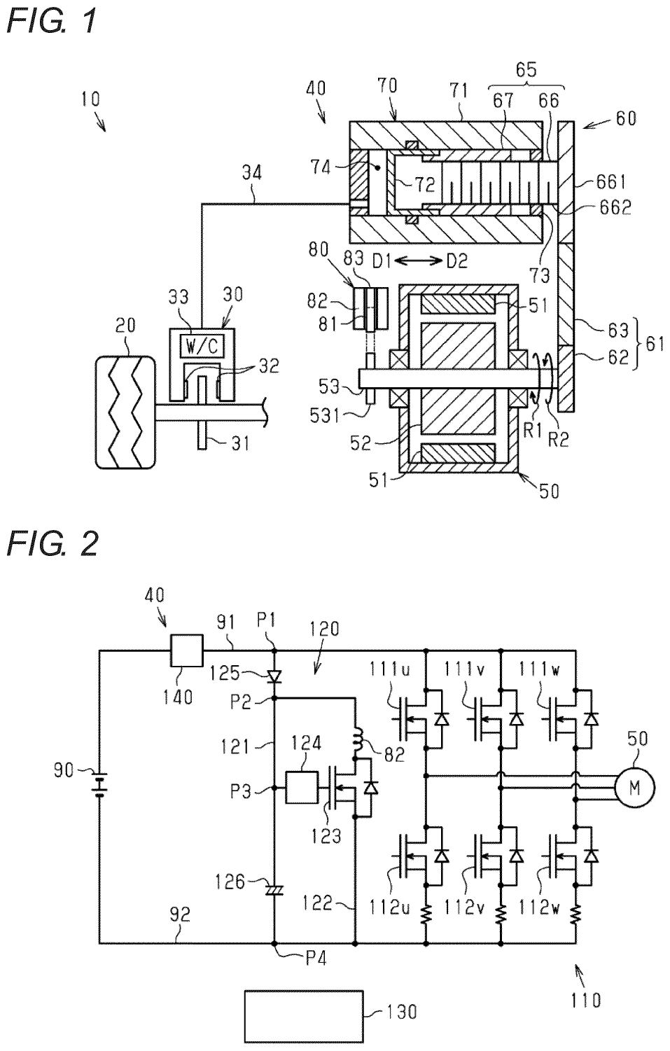

As illustrated in FIG. 1, a vehicle 10 includes a wheel 20, a braking mechanism 30, and an electric braking device 40. FIG. 1 illustrates a part of the constituent elements of the vehicle 10.

### <Braking Mechanism>

The braking mechanism 30 includes a brake rotor 31 that rotates together with the wheel 20, a friction member 32 that does not rotate integrally with the wheel 20, and a wheel cylinder 33 that displaces the friction member 32 toward the brake rotor 31 in response to fluid pressure. The wheel cylinder 33 is connected to the electric braking device 40 via a liquid path 34. The braking mechanism 30 applies a larger braking force to the wheel 20 by strongly pressing the friction member 32 against the brake rotor 31 as the fluid pressure of the wheel cylinder 33 is higher. The brake rotor 31 corresponds to an example of the “portion subjected to friction”, and the friction member 32 corresponds to an example of the “friction portion”.

### <Mechanical Configuration of Electric Braking Device>

The electric braking device 40 includes an electric motor 50, a transmission device 60, an electric cylinder mechanism 70, and an actuator 80.

The electric motor 50 is a brushless direct-current motor, and includes a stator 51, a rotor 52, and an output shaft 53. The stator 51 is configured to include a u-phase coil, a v-phase coil, and a w-phase coil. By controlling energization to each coil, the rotor 52 and the output shaft 53 rotate in a first rotational direction R1 or a second rotational direction R2, which is the opposite direction of the first rotational direction R1. A ratchet gear 531 is fixed to the output shaft 53. The ratchet gear 531 rotates together with the output shaft 53.

The transmission device 60 transmits power between the electric motor 50 and the electric cylinder mechanism 70. The transmission device 60 includes a deceleration mechanism 61 that decelerates the rotational speed of the output shaft 53 of the electric motor 50, and a linear motion conversion mechanism 65 that converts a rotational motion into a linear motion. In the transmission device 60, when the electric motor 50 is driven, the power of the electric motor 50 is transmitted from the deceleration mechanism 61 to the linear motion conversion mechanism 65 and is output to the electric cylinder mechanism 70.

The deceleration mechanism 61 includes a first gear 62 fixed to the output shaft 53 of the electric motor 50 and a second gear 63 that meshes with the first gear 62. Since the number of teeth of the second gear 63 is greater than the number of teeth of the first gear 62, the rotational speed of the second gear 63 becomes slower than the rotational speed of the first gear 62. While the number of gears is two in the present example, the deceleration mechanism 61 may be configured by meshing three or more gears. In this respect, the deceleration mechanism 61 corresponds to the “transmission mechanism”, and the second gear 63 corresponds to a “deceleration portion”. Note that in FIG. 1, the rotation axis of the first gear 62 and the rotation axis of the second gear 63 are in a parallel positional relationship, but the rotation axis of the first gear 62 and the rotation axis of the second gear 63 may be in a twisted positional relationship.

The linear motion conversion mechanism 65 is, for example, a ball screw mechanism, a feed screw mechanism, or the like. The linear motion conversion mechanism 65 includes a rotating member 66 that rotates based on the power transmitted from the deceleration mechanism 61, and a linear motion member 67 that moves in the axial direction of the rotating member 66 with the rotation of the rotating member 66.

The rotating member 66 includes a third gear 661 that meshes with the second gear 63 of the deceleration mechanism 61, and a screw shaft 662 extending in the axial direction of the third gear 661 from the third gear 661. The linear motion member 67 is not rotatable about the axis of the rotating member 66 and is movable in the axial direction of the rotating member 66. In the linear motion conversion mechanism 65, when the rotating member 66 rotates, the linear motion member 67 moves in the axial direction of the rotating member 66.

The electric cylinder mechanism 70 includes an electric cylinder 71, a piston 72 accommodated in the electric cylinder 71, and a stopper 73 that defines a movement range of the piston 72. The electric cylinder mechanism 70 has a liquid chamber 74 defined by the electric cylinder 71 and the piston 72.

Together with the piston 72, the electric cylinder 71 accommodates the screw shaft 662 and the linear motion member 67. Inside the electric cylinder 71, the piston 72 and the linear motion member 67 are coupled. Therefore, when the linear motion member 67 moves in the axial direction of the electric cylinder 71, the piston 72 moves in the first direction D1 or the second direction D2, which is the opposite direction of the first direction D1, together with the linear motion member 67. In this respect, the linear motion of the linear motion member 67 is a linear motion that drives the piston 72.

The stopper 73 defines a terminal in the second direction D2 in the movement range of the piston 72. In the present embodiment, the linear motion member 67 moving in the second direction D2 together with the stopper 73 comes into contact with the stopper 73, whereby the piston 72 is restricted from movement in the second direction D2. The stopper 73 can be configured by a wall part of the electric cylinder 71 or can be configured by a member different from the electric cylinder 71.

The liquid chamber 74 is filled with brake fluid. The liquid chamber 74 is connected to the wheel cylinder 33 of the braking mechanism 30 via the liquid path 34. When the piston 72 moves in the first direction D1 where the volume of the liquid chamber 74 decreases, the brake fluid flows out from the liquid chamber 74 toward the wheel cylinder 33. On the other hand, when the piston 72 moves in the second direction D2 where the volume of the liquid chamber 74 increases, the brake fluid flows into the liquid chamber 74 from the wheel cylinder 33.

In the electric braking device 40 described above, when the output shaft 53 of the electric motor 50 rotates, the power of the electric motor 50 is transmitted to the piston 72 via the transmission device 60. When the output shaft 53 of the electric motor 50 rotates in the first rotational direction R1, that is, when the piston 72 moves in the first direction D1, the brake fluid flows into the wheel cylinder 33, and therefore the fluid pressure of the wheel cylinder 33 increases. That is, the force with which the friction member 32 pushes the brake rotor 31 increases, and the braking force applied to the wheel 20 increases. On the other hand, when the output shaft 53 of the electric motor 50 rotates in the second rotational direction R2, that is, when the piston 72 moves in the second direction D2, the brake fluid flows out from the wheel cylinder 33, and therefore the fluid pressure of the wheel cylinder 33 decreases. That is, the force with which the friction member 32 pushes the brake rotor 31 decreases, and the braking force applied to the wheel 20 decreases. In this respect, the first rotational direction R1 corresponds to the “braking force increasing direction”, and the first direction D1 corresponds to the “increasing direction”. On the other hand, the second rotational direction R2 corresponds to the “braking force decreasing direction”, and the second direction D2 corresponds to the “decreasing direction”.

The actuator 80 is a so-called solenoid actuator. The actuator 80 includes a plunger 81 having a columnar shape, a coil 82 that generates a magnetic field for driving the plunger 81, and a housing 83 that accommodates the plunger 81 and the coil 82. A tip end of the plunger 81 has a pawl shape that can be locked to the ratchet gear 531. By being energized, the coil 82 generates a magnetic field for driving the plunger 81. In the present embodiment, when the coil 82 is not energized, the plunger 81 is positioned at an accommodation position to be accommodated in the housing 83. On the other hand, when energized to the coil 82, the plunger 81 is positioned at a protrusion position protruding from the housing 83. In the state where the coil 82 is energized is maintained, the plunger 81 continues to be positioned in the protrusion position.

The actuator 80 is disposed such that the protrusion direction of the plunger 81 faces the ratchet gear 531 to be fixed to the output shaft 53 of the electric motor 50. As indicated by a solid line in FIG. 1, when the plunger 81 is disposed at the accommodation position, the plunger 81 is not locked to the ratchet gear 531. On the other hand, as indicated by a two-dot chain line in FIG. 1, when the plunger 81 is disposed at the protrusion position, the plunger 81 is locked to the ratchet gear 531. When the plunger 81 is disposed at the protrusion position in a situation where the output shaft 53 of the electric motor 50 is rotating, the rotational speed of the output shaft 53 greatly decreases. In this manner, the actuator 80 strongly interrupts the rotation of the output shaft 53 by locking the plunger 81 to the ratchet gear 531. Note that the ratchet gear 531 may be configured to interrupt the rotation of the output shaft 53 by locking with the plunger 81 under a situation where the output shaft 53 is rotating in at least the second rotational direction R2.

### <Electrical Configuration of Electric Braking Device>

As illustrated in FIG. 2, the electric braking device 40 includes a direct-current electric power source 90, a positive electrode line 91 and a negative electrode line 92, a first drive circuit 110, a second drive circuit 120, a control device 130, and a switching element 140.

The positive electrode line 91 is connected to the positive electrode of the direct-current electric power source 90. The negative electrode line 92 is connected to the negative electrode of the direct-current electric power source 90.

The first drive circuit 110 is an inverter circuit that drives the electric motor 50. The first drive circuit 110 includes a plurality of switching elements 111u, 112u, 111v, 112v, 111w, and 112w.

Among the plurality of switching elements, the switching elements 111u, 111v, and 111w are connected to the positive electrode line 91, and the switching elements 112u, 112v, and 112w are connected to the negative electrode line 92. The two switching elements 111u and 112u correspond to the u-phase coils of the electric motor 50. The two switching elements 111v and 112v correspond to the v-phase coils of the electric motor 50. The two switching elements 111w and 112w correspond to the w-phase coils of the electric motor 50.

By periodically turning on/off the plurality of switching elements 111u, 112u, 111v, 112v, 111w, and 112w, the first drive circuit 110 converts the direct-current electric power input from the direct-current electric power source 90 into an alternating-current electric power. Thus, the first drive circuit 110 supplies the alternating-current electric power to the u-phase coil, the v-phase coil, and the w-phase coil of the electric motor 50.

The second drive circuit 120 is a circuit that drives the actuator 80. The second drive circuit 120 includes a first connection line 121 and a second connection line 122, a switching element 123, a switching circuit 124, a diode 125, and a capacitor 126. The second drive circuit 120 is provided with the coil 82 of the actuator 80.

The first connection line 121 connects the positive electrode line 91 and the negative electrode line 92. The second connection line 122 connects the first connection line 121 and the negative electrode line 92. The coil 82 and the switching element 123 are provided in series with the second connection line 122. The switching element 123 switches an energization state of the coil 82. Specifically, the coil 82 is energized when the switching element 123 is on, and the coil 82 is not energized when the switching element 123 is off. The switching element 123 is, for example, a MOSFET.

The switching circuit 124 is a circuit that controls on/off of the switching element 123. The switching circuit 124 controls the switching element 123 based on an identification signal output from the control device 130. The identification signal output from the control device 130 to the switching circuit 124 is a signal indicating whether or not the electric power supply to the electric motor 50 is normal. The identification signal when the electric power supply to the electric motor 50 is normal is a normal signal, and the identification signal when the electric power supply to the electric motor 50 is abnormal is an abnormal signal. At this time, when the identification signal is a normal signal, the switching circuit 124 turns off the switching element 123. In other words, the switching circuit 124 prohibits the switching element 123 from being turned from off to on. On the other hand, when the identification signal is an abnormal signal, the switching circuit 124 permits the switching element 123 to be turned from off to on. In this case, when a current flows from the first connection line 121 to the switching circuit 124, the switching circuit 124 turns on the switching element 123. The switching circuit 124 corresponds to an example of a “switching portion”. Note that the case where the identification signal is an abnormal signal is a case where a power failure is generated in the direct-current electric power source 90, for example.

The diode 125 is provided in the first connection line 121. Specifically, when a connection point between the first connection line 121 and the positive electrode line 91 is a connection point P1 and a connection point between the first connection line 121 and the second connection line 122 is a connection point P2, the diode 125 is provided in a part between the connection point P1 and the connection point P2 in the first connection line 121. The diode 125 permits a current flow from the connection point P1 to the connection point P2 and restricts a current flow from the connection point P2 to the connection point P1.

The capacitor 126 is provided in the first connection line 121. Specifically, when a connection point between the first connection line 121 and the switching circuit 124 is a connection point P3 and a connection point between the first connection line 121 and the negative electrode line 92 is a connection point P4, the capacitor 126 is provided in a part between the connection point P3 and the connection point P4 in the first connection line 121. The capacitor 126 is charged when a current flows from the connection point P1 toward the connection point P3 through the first connection line 121. When the current stops flowing through the first connection line 121 in a state where the capacitor 126 stores the charge, the capacitor 126 discharges toward the switching circuit 124. The capacitor 126 corresponds to an “electric power supply portion”.

The switching element 140 is provided in a path between the direct-current electric power source 90 and the connection point P1. The switching element 140 is turned off when the electric braking device 40 is abnormal. As a result, for example, when the voltage of the direct-current electric power source 90 decreases, the electric power generated by the electric motor 50 can be inhibited from being supplied to the direct-current electric power source 90.

The control device 130 controls the first drive circuit 110 based on a control signal output from a braking control device that calculates a required braking force required for the vehicle 10. By periodically turning on/off the plurality of switching elements 111u, 112u, 111v, 112v, 111w, and 112w, the control device 130 adjusts the rotational speed and the rotational direction of the output shaft 53 of the electric motor 50. Thus, the control device 130 adjusts the braking force applied to the wheel 20. The control device 130 outputs the above-described identification signal toward the switching circuit 124.

### <Operations and Effects of First Embodiment>

When a control signal corresponding to the required braking force is input from the braking control device to the electric braking device 40, the first drive circuit 110 is driven. When the required braking force is increased, the output shaft 53 of the electric motor 50 is rotated in the first rotational direction R1. Then, the piston 72 moves in the first direction D1, whereby the brake fluid flows out to the wheel cylinder 33 from the liquid chamber 74 of the electric cylinder 71. As a result, the fluid pressure of the wheel cylinder 33 increases, and the braking force applied to the wheel 20 increases.

When electric power is normally supplied to the first drive circuit 110 and the second drive circuit 120, the switching element 123 of the second drive circuit 120 is turned off. Therefore, the coil 82 is not energized because no current flows through the second connection line 122. That is, the switching circuit 124 prohibits the operation of the actuator 80 when the electric power supply to the electric motor 50 is normal. As a result, the plunger 81 of the actuator 80 is disposed at the accommodation position. On the other hand, the capacitor 126 is charged because a current flows through the first connection line 121.

Under a situation where the electric braking device 40 applies the wheel 20 with the braking force, when any abnormality is generated in the direct-current electric power source 90, there is a case where the electric power is not normally supplied to the first drive circuit 110, the second drive circuit 120, and the control device 130.

When the first drive circuit 110 is no longer supplied with the electric power, the electric motor 50 can no longer be driven, and therefore there is no longer a force for pushing the piston 72 in the first direction D1. Then, the brake fluid flows into the liquid chamber 74 of the electric cylinder 71 from the wheel cylinder 33, whereby the piston 72 moves in the second direction D2. That is, the piston 72 moves in the second direction D2 by an external force.

When the piston 72 moves in the second direction D2, the output shaft 53 of the electric motor 50 rotates in the second rotational direction R2 based on the power transmitted from the piston 72. As a result, the electric motor 50 generates electric power. Then, a current flows from the electric motor 50 to the positive electrode line 91 via freewheeling diodes of the switching elements 111u, 111v, and 111w. As a result, the electric power generated by the electric motor 50 is supplied to the second drive circuit 120. Note that when the output shaft 53 of the electric motor 50 rotates in the second rotational direction R2, the rotor 52 of the electric motor 50 also rotates in the second rotational direction R2, and therefore moment of inertia occurs. Therefore, even if the flow rate of the brake fluid flowing into the liquid chamber 74 of the electric cylinder 71 from the wheel cylinder 33 decreases, the piston 72 is toward continuous movement in the second direction D2 by the moment of inertia of the rotor 52.

When electric power is no longer supplied from the direct-current electric power source 90 to the second drive circuit 120 and the control device 130, the switching circuit 124 permits the switching element 123 to be switched from off to on based on the identification signal output from control device 130. When electric power is supplied from the first drive circuit 110 to the second drive circuit 120 by the power generation of the electric motor 50 under such situation, a current flows from the first connection line 121 to the switching circuit 124. As a result, the switching circuit 124 turns on the switching element 123. Then, a current flows through the second connection line 122, and the coil 82 is energized. Thus, when the electric power supply to the electric motor 50 is abnormal, the switching circuit 124 permits the operation of the actuator 80.

As indicated by the solid line and the two-dot chain line in FIG. 1, when the coil 82 is energized, the plunger 81 of the actuator 80 is displaced from the accommodation position to the protrusion position. Then, the plunger 81 is locked to the ratchet gear 531, whereby the rotational speed of the output shaft 53 of the electric motor 50 decreases. Thus, using the electric power generated by the electric motor 50, the actuator 80 inhibits movement of the piston 72 in the second direction D2. Therefore, the piston 72 is inhibited from being pushed back vigorously in the second direction D2, and the impact when the piston 72 runs into can be mitigated at the terminal in the second direction D2 in the movement range of the piston 72. Specifically, it is possible to mitigate the impact when the linear motion member 67 moving in the second direction D2 together with the piston 72 runs into the stopper 73. As a result, the electric braking device 40 can inhibit durability of the components of the device from decreasing.

The first embodiment can further obtain the following effects.
(1) The second drive circuit 120 includes the capacitor 126. The capacitor 126 is fully charged when the electric power has been supplied from the direct-current electric power source 90 to the second drive circuit 120. Therefore, when electric power is no longer supplied from the direct-current electric power source 90 to the second drive circuit 120 and a current no longer flows through the first connection line 121, the capacitor 126 quickly starts discharging to the switching circuit 124. In other words, the capacitor 126 supplies electric power to the switching circuit 124 when the electric power supply to the electric motor 50 is abnormal. Thus, the electric braking device 40 can quickly turn on the switching element 123 when electric power is no longer supplied from the direct-current electric power source 90 to the first drive circuit 110 and the second drive circuit 120. Therefore, the electric braking device 40 can quickly start the operation of the actuator 80.
(2) The actuator 80 interrupts rotation of the output shaft 53 of the electric motor 50 before being decelerated by the deceleration mechanism 61. In other words, the actuator 80 interrupts the operation on the electric motor 50 side relative to the second gear 63 of the deceleration mechanism 61 in a transmission path of output torque of the electric motor 50. Therefore, for example, the actuator 80 can efficiently inhibit the movement of the piston 72 in the second direction D2 as compared with a case where the rotation of a rotating body after being decelerated by the deceleration mechanism 61 is configured to be interrupted.

### Second Embodiment

Hereinafter, an electric braking device 40A according to the second embodiment will be described. In the description of the second embodiment, constituent elements in common with those of the first embodiment are denoted by identical reference signs, and the description will be omitted.

### <Electric Braking Device>

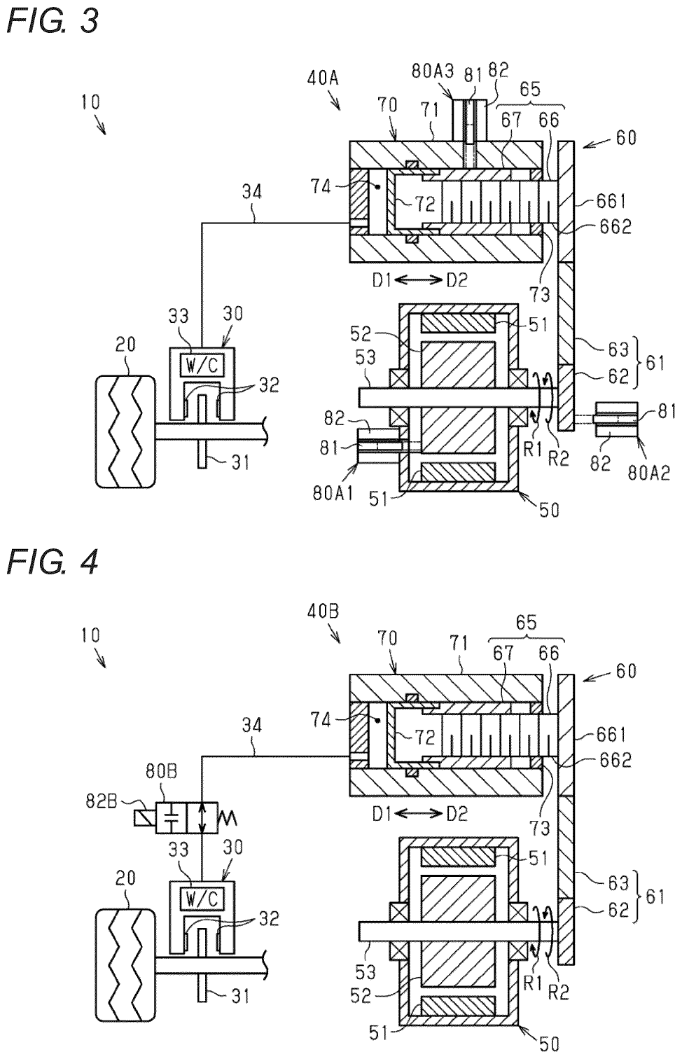

As illustrated in FIG. 3, the electric braking device 40A includes the electric motor 50, the transmission device 60, the electric cylinder mechanism 70, and a plurality of actuators 80A1 to 80A3. The electrical configuration of the electric braking device 40A is substantially the same as that of the first embodiment except that three coils 82 are arranged in series in the second connection line 122 of the second drive circuit 120.

The plurality of actuators 80A1 to 80A3 are configured substantially similarly to the actuator 80 in the first embodiment. In the second embodiment, the tip end of the plunger 81 needs not have a pawl shape in that the engagement target of the plunger 81 is no longer the ratchet gear 531. The first actuator 80A1 is disposed such that the rotor 52 of the electric motor 50 is positioned in the protrusion direction of the plunger 81. The second actuator 80A2 is disposed such that the first gear 62 of the deceleration mechanism 61 is positioned in the protrusion direction of the plunger 81. The third actuator 80A3 is disposed such that the linear motion member 67 of the linear motion conversion mechanism 65 is positioned in the protrusion direction of the plunger 81.

### <Operations and Effects of Second Embodiment>

When electric power is no longer supplied from the direct-current electric power source 90 to the first drive circuit 110 and the second drive circuit 120, the electric power generated by the electric motor 50 is supplied to the second drive circuit 120, thereby driving the plurality of actuators 80A1 to 80A3.

Specifically, by bringing the plunger 81 into contact with the rotor 52 of the electric motor 50, the first actuator 80A1 interrupts the rotation of the rotor 52 of the electric motor 50. That is, the rotational speed of the output shaft 53 decreases due to friction between the plunger 81 of the first actuator 80A1 and the rotor 52. By bringing the plunger 81 into contact with the first gear 62 of the deceleration mechanism 61, the second actuator 80A2 interrupts the rotation of the first gear 62. That is, the rotational speed of the output shaft 53 decreases due to friction between the plunger 81 of the second actuator 80A2 and the first gear 62. By bringing the plunger 81 into contact with the linear motion member 67 of the linear motion conversion mechanism 65, the third actuator 80A3 interrupts the movement of the plunger 81. That is, the moving speed of the linear motion member 67 decreases due to friction between the plunger 81 of the third actuator 80A3 and the linear motion member 67. Thus, the electric braking device 40A can inhibit the movement of the piston 72 in the second direction D2. That is, the electric braking device 40A can inhibit durability of the components of the device from decreasing.

Note that in the second embodiment, the electric braking device 40A may include at least one actuator among the plurality of actuators 80A1 to 80A3. In the second embodiment, the electric braking device 40A may include an actuator that interrupts the operation of a power transmission element constituting a part of the power transmission path from the electric motor 50 to the piston 72. For example, the electric braking device 40A may include an actuator that interrupts rotation of the second gear 63 of the deceleration mechanism 61, or may include an actuator that interrupts rotation of the rotating member 66 of the linear motion conversion mechanism 65. The electric braking device 40A may include an actuator that interrupts the operation of the piston 72.

### Third Embodiment

Hereinafter, an electric braking device 40B according to the third embodiment will be described. In the description of the third embodiment, constituent elements in common with those of the first embodiment are denoted by identical reference signs, and the description will be omitted.

### <Electric Braking Device>

As illustrated in FIG. 4, the electric braking device 40B includes the electric motor 50, the transmission device 60, the electric cylinder mechanism 70, and an actuator 80B. The electrical configuration of the electric braking device 40B is substantially the same as that of the first embodiment.

The actuator 80B is a normally-open solenoid valve provided in the liquid path 34 connecting the liquid chamber 74 and the wheel cylinder 33. The actuator 80B includes a coil 82B that generates a magnetic field for driving the actuator 80B. When the actuator 80B is opened, the brake fluid can move between the liquid chamber 74 and the wheel cylinder 33. When the actuator 80B is closed, the brake fluid cannot move between the liquid chamber 74 and the wheel cylinder 33. Note that when the actuator 80B is closed, the brake fluid is sealed in the wheel cylinder 33, and therefore a liquid path for releasing this sealed brake fluid may be provided between the wheel cylinder 33 and the actuator 80B.

### <Operations and Effects of Third Embodiment>

When electric power is no longer supplied from the direct-current electric power source 90 to the first drive circuit 110 and the second drive circuit 120, the electric power generated by the electric motor 50 is supplied to the second drive circuit 120, thereby driving the actuator 80B. Specifically, since the actuator 80B is closed, the brake fluid does no longer flow into the liquid chamber 74 of the electric cylinder 71 from the wheel cylinder 33. In other words, the actuator 80B weakens the flow of the brake fluid from the wheel cylinder 33 to the piston 72 of the electric cylinder 71. Thus, the electric braking device 40B can inhibit the movement of the piston 72 in the second direction D2. That is, the electric braking device 40B can inhibit durability of the components of the device from decreasing.

### Fourth Embodiment

Hereinafter, an electric braking device 40C according to the fourth embodiment will be described. In the description of the fourth embodiment, constituent elements in common with those of the first embodiment are denoted by identical reference signs, and the description will be omitted.

### <Electric Braking Device>

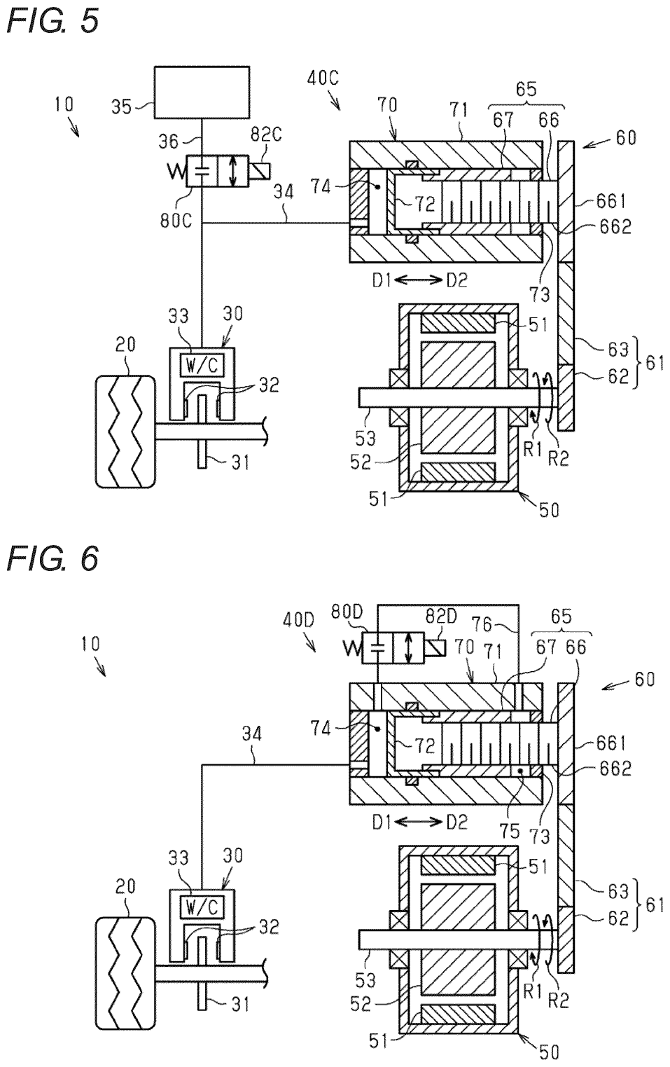

As illustrated in FIG. 5, the vehicle 10 includes an atmospheric pressure reservoir 35 that stores brake fluid, and a liquid path 36 that connects the liquid path 34 and the atmospheric pressure reservoir 35. The internal pressure of the atmospheric pressure reservoir 35 is equivalent to the atmospheric pressure. The electric braking device 40C includes the electric motor 50, the transmission device 60, the electric cylinder mechanism 70, and an actuator 80C. Note that the electrical configuration of the electric braking device 40C is substantially the same as that of the first embodiment.

The actuator 80C is a normally-closed solenoid valve provided in the liquid path 36. The actuator 80C includes a coil 82C that generates a magnetic field for driving the actuator 80C. When the actuator 80C is closed, the brake fluid cannot move between the wheel cylinder 33 and the liquid chamber 74 and the atmospheric pressure reservoir 35. When the actuator 80C is opened, the brake fluid can move between the wheel cylinder 33 and the liquid chamber 74 and the atmospheric pressure reservoir 35.

### <Operations and Effects of Fourth Embodiment>

When electric power is no longer supplied from the direct-current electric power source 90 to the first drive circuit 110 and the second drive circuit 120, the electric power generated by the electric motor 50 is supplied to the second drive circuit 120, thereby driving the actuator 80C. Specifically, since the actuator 80C is opened, a part of the brake fluid flowing from the wheel cylinder 33 toward the liquid chamber 74 of the electric cylinder 71 flows out to the atmospheric pressure reservoir 35. In other words, the actuator 80C weakens the flow of the brake fluid from the wheel cylinder 33 to the piston 72 of the electric cylinder 71. Thus, the electric braking device 40C can inhibit the movement of the piston 72 in the second direction D2. That is, the electric braking device 40C can inhibit durability of the components of the device from decreasing.

### Fifth Embodiment

Hereinafter, an electric braking device 40D according to the fifth embodiment will be described. In the description of the fifth embodiment, constituent elements in common with those of the first embodiment are denoted by identical reference signs, and the description will be omitted.

### <Electric Braking Device>

As illustrated in FIG. 6, the electric braking device 40D includes the electric motor 50, the transmission device 60, the electric cylinder mechanism 70, and an actuator 80D. The electrical configuration of the electric braking device 40D is substantially the same as that of the first embodiment.

The electric cylinder mechanism 70 includes a first liquid chamber 74 defined by the electric cylinder 71 and the piston 72, a second liquid chamber 75 defined by the linear motion member 67, the electric cylinder 71, and the stopper 73, and a liquid path 76 connecting the first liquid chamber 74 and the second liquid chamber 75. In the fifth embodiment, the stopper 73 also functions as a seal that closes a gap between the electric cylinder 71 and the screw shaft 662 of the rotating member 66. The internal pressure of the second liquid chamber 75 is lower than the internal pressure of the first liquid chamber 74 when the wheel 20 is applied with the braking force by the operation of the electric cylinder mechanism 70.

The actuator 80D is provided in the liquid path 76. The actuator 80D is a normally-closed solenoid valve. The actuator 80D includes a coil 82D that generates a magnetic field for driving the actuator 80D. When the actuator 80D is closed, the brake fluid cannot move between the first liquid chamber 74 and the second liquid chamber 75. When the actuator 80D is open, the brake fluid can move between the first liquid chamber 74 and the second liquid chamber 75.

### <Operations and Effects of Fifth Embodiment>

When electric power is no longer supplied from the direct-current electric power source 90 to the first drive circuit 110 and the second drive circuit 120, the electric power generated by the electric motor 50 is supplied to the second drive circuit 120, thereby driving the actuator 80D. Specifically, since the actuator 80D is opened, a part of the brake fluid flowing into the first liquid chamber 74 from the wheel cylinder 33 flows out to the second liquid chamber 75. Thus, the electric braking device 40D can inhibit the movement of the piston 72 in the second direction D2. That is, the electric braking device 40D can inhibit durability of the components of the device from decreasing.

### Modifications

The plurality of embodiments can be modified and carried out as follows. The plurality of embodiments and the following modifications can be carried out in combination with each other within a range not technically contradictory.
The electric braking devices 40 and 40A to 40D may be a dry type device that displaces the friction member 32 with respect to the brake rotor 31 via no brake fluid. Specifically, the electric braking devices 40 and 40A to 40D may be configured to press the friction member 32 against the brake rotor 31 by directly pressing the friction member 32 with the piston 72.
The electric braking device 40 needs not include the ratchet gear 531. The actuator 80 may decrease the rotational speed of the output shaft 53 by bringing the plunger 81 into contact with the output shaft 53 of the electric motor 50. In this case, processing for increasing friction between the plunger 81 and the output shaft 53 may be performed on the tip end of the plunger 81 and the outer peripheral surface of the output shaft 53, or the outer peripheral surface of the output shaft 53 may be provided with an uneven shape.
The deceleration mechanism 61 may transmit the output of the electric motor 50 to the linear motion conversion mechanism 65 without decelerating the rotational speed of the output shaft 53 of the electric motor 50.
The electric cylinder 71 may include an elastic body such as a coil spring that biases the piston 72 in the second direction D2.
The actuator 80 needs not be a solenoid actuator as long as it is an actuator driven by electric power generated by the electric motor 50. For example, the actuator 80 may include an electric motor.
The actuator 80 needs not be a linear type actuator but may be a rotary type actuator.
The electric motor 50 may be a brushed motor or an alternating-current motor. In these cases, it is preferable to appropriately change the configuration of the drive circuit.
The circuit configuration of the second drive circuit 120 can be changed as appropriate. The second drive circuit 120 may be configured to supply the electric power generated by the electric motor 50 to the actuator 80 when the electric motor 50 generates electric power.
When the electric motor 50 generates electric motor, the second drive circuit 120 needs not include the capacitor 126 as long as a current can flow through the switching circuit 124.
When the power supply source for the control device 130 is the direct-current electric power source 90, the identification signal may be a signal that is always on when the control device 130 is supplied with electric power. Due to this, when the direct-current electric power source 90 cannot normally supply electric power, in other words, when the control device 130 cannot be supplied with electric power and therefore an identification signal cannot be transmitted to the switching circuit 124, the signal is automatically turned off. Therefore, the switching circuit 124 can select the on/off state of the switching element 123 in response to whether or not an identification signal has been transmitted from the control device 130.

1. An electric braking device that generates a braking force on a vehicle by transmitting, to a linear motion conversion mechanism by a transmission mechanism, a rotational motion generated by an electric motor rotating in a braking force increasing direction, converting the rotational motion into a linear motion for driving a piston provided in a cylinder by the linear motion conversion mechanism, and pressing a friction portion against a portion subjected to friction that rotates together with a wheel of a vehicle, the electric braking device comprising:
an actuator that is driven to inhibit movement of the piston in a decreasing direction by using electric power generated by the electric motor by the electric motor rotating in a braking force decreasing direction when the electric motor rotates in the braking force decreasing direction, which is a direction opposite to the braking force increasing direction, by the piston moving in the decreasing direction that is a direction in which the braking force decreases by an external force.

2. The electric braking device according to claim 1, wherein
the actuator inhibits movement in the decreasing direction of the piston by interrupting operation of at least one of the electric motor, the transmission mechanism, the linear motion conversion mechanism, and the piston.

3. The electric braking device according to claim 2, wherein
the transmission mechanism includes a deceleration portion that decelerates and transmits, to the linear motion conversion mechanism, rotation of the electric motor, and
the actuator inhibits movement in the decreasing direction of the piston by interrupting operation the electric motor side relative to the deceleration portion of the transmission mechanism closer in a transmission path of output torque of the electric motor.

4. The electric braking device according to claim 1, wherein
the electric braking device presses the friction portion against the portion subjected to friction by supplying a brake fluid to a wheel cylinder, and
the actuator inhibits movement in the decreasing direction of the piston by weakening a flow of a brake fluid from the wheel cylinder to the piston in the cylinder.

5. The electric braking device according to claim 4, further comprising:
a switching portion that prohibits operation of the actuator when electric power supply to the electric motor is normal, and permits operation of the actuator when electric power supply to the electric motor is abnormal.

6. The electric braking device according to claim 5, further comprising:
an electric power supply portion that supplies the switching portion with electric power when electric power supply to the electric motor is abnormal.

7. The electric braking device according to claim 3, further comprising: a switching portion that prohibits operation of the actuator when electric power supply to the electric motor is normal, and permits operation of the actuator when electric power supply to the electric motor is abnormal.

8. The electric braking device according to claim 7, further comprising: an electric power supply portion that supplies the switching portion with electric power when electric power supply to the electric motor is abnormal.

9. The electric braking device according to claim 2, further comprising: a switching portion that prohibits operation of the actuator when electric power supply to the electric motor is normal, and permits operation of the actuator when electric power supply to the electric motor is abnormal.

10. The electric braking device according to claim 9, further comprising: an electric power supply portion that supplies the switching portion with electric power when electric power supply to the electric motor is abnormal.

11. The electric braking device according to claim 1, wherein
the transmission mechanism includes a deceleration portion that decelerates and transmits, to the linear motion conversion mechanism, rotation of the electric motor, and
the actuator inhibits movement in the decreasing direction of the piston by interrupting operation the electric motor side relative to the deceleration portion of the transmission mechanism closer in a transmission path of output torque of the electric motor.

12. The electric braking device according to claim 11, further comprising: a switching portion that prohibits operation of the actuator when electric power supply to the electric motor is normal, and permits operation of the actuator when electric power supply to the electric motor is abnormal.

13. The electric braking device according to claim 12, further comprising: an electric power supply portion that supplies the switching portion with electric power when electric power supply to the electric motor is abnormal.

14. The electric braking device according to claim 1, further comprising: a switching portion that prohibits operation of the actuator when electric power supply to the electric motor is normal, and permits operation of the actuator when electric power supply to the electric motor is abnormal.

15. The electric braking device according to claim 14, further comprising: an electric power supply portion that supplies the switching portion with electric power when electric power supply to the electric motor is abnormal.
